(19) United States
(12) Patent Application Publication
(10) Pub. No.: US 2011/0161689 A1
(43) Pub. Date: Jun. 30, 2011

(54) CARD PERIPHERAL DEVICE AND CARD SYSTEM

(75) Inventors: Yoshitaka Aoki, Kanagawa (JP); Katsuyuki Honda, Kanagawa (JP)

(73) Assignee: SONY CORPORATION, Tokyo (JP)

(21) Appl. No.: 12/959,734

(22) Filed: Dec. 3, 2010

(30) Foreign Application Priority Data
Dec. 25, 2009 (JP) 2009-294082

(51) Int. Cl. G06F 13/10; G06F 1/26

(52) U.S. Cl. 713/300; 710/33

(57) ABSTRACT

Disclosed herein is a card peripheral device including, an electronic part unit, a connector part, and a power supply unit, wherein the electronic part unit includes a controller, and at least a second interface, out of a first interface and the second interface, and the controller has a function to vary data transfer speed depending on whether power feed of the first power by the power supply terminal is received or the second power by the power supply unit is received.

### BACKGROUND OF THE INVENTION

1. Field of the Invention

The present invention relates to a card peripheral device such as a memory card and a card system.

2. Description of the Related Art

In the case of a general memory card, when it is inserted into a connector of connection-subject apparatus, contact pins of the connector are in contact with a signal terminal and a power supply terminal disposed in the card. In this state, power is supplied to the card via the power supply terminal, and data reading and writing with a host device are performed via the signal terminal.

A card peripheral device of this kind is disclosed in Japanese Patent Laid-open No. 2009-59253 and so forth.

Furthermore, a card capable of wireless data transfer is also being put into practical use.

This card having the wireless communication function requires power feed from a connector regarding power supply.

As for wireless power supply, which is mainly based on the principle of electromagnetic induction, at most about 80% is expected as its supply efficiency.

### SUMMARY OF THE INVENTION

However, as described above, the card having the wireless communication function requires power feed from a connector regarding power supply, and recording and reading to and from the memory card are impossible unless a connector and a slot intervene as a mechanical interface with the host.

Furthermore, at present, the wireless data transfer requires higher power consumption compared with wired connection.

In the case of the wireless power supply, which is mainly based on the principle of electromagnetic induction, at most about 80% is expected as its supply efficiency. Therefore, when high power is supplied to the card, the lost power also becomes high in proportion.

Most of the lost power is converted to heat, which possibly gives a thermal influence on the host apparatus and the card.

In addition, possibly the power for transferring data at high speed cannot be supplied because of restrictions on the size of the secondary-side coil mounted on the card side.

In particular, if the power supply is carried out by using a battery of portable apparatus, the power supply significantly suffers from the influence.

There is a need for the present invention to provide a card peripheral device and a card system capable of accordingly selecting and handling power supply and data transmission and reception depending on the necessary transfer speed and the power consumption.

According to a first embodiment of the present invention, there is provided a card peripheral device including an electronic part unit configured to include a memory housed in a case body and receive first power or second power as operating power, and a connector part configured to include at least a power supply terminal for receiving the first power from connection-subject apparatus, out of the power supply terminal and a signal terminal, as a connection terminal connectable to the connection-subject apparatus. The card peripheral device further includes a power supply unit configured to receive power transmitted from the external in a non-contact manner to generate the second power and supply the second power to the electronic part unit. The electronic part unit includes a controller and at least a second interface, out of a first interface capable of data transfer with the external via the signal terminal in accordance with control by the controller and the second interface capable of wireless data transfer with the external in accordance with control by the controller. The controller has a function to vary the data transfer speed depending on whether power feed of the first power by the power supply terminal is received or the second power by the power supply unit is received.

According to a second embodiment of the present invention, there is provided a card system including a card peripheral device configured to have a connector part, a first host device configured to be connected to the card peripheral device via the connector part and be capable of supplying first power, a second host device configured to be capable of wireless communication with the card peripheral device, and a power supply device configured to be capable of transmitting power to the card peripheral device in a non-contact manner. The card peripheral device includes an electronic part unit that includes a memory housed in a case body and receives the first power or second power as operating power, and the connector part that includes at least a power supply terminal for receiving the first power from the first host device, out of the power supply terminal and a signal terminal, as a connection terminal connectable to the first host device. The card peripheral device further includes a power supply unit that receives power transmitted from the external in a non-contact manner to generate the second power and supply the second power to the electronic part unit. The electronic part unit includes a controller and at least a second interface, out of a first interface capable of data transfer with the first host device via the signal terminal in accordance with control by the controller and the second interface capable of wireless data transfer with the second host device in accordance with control by the controller. The controller has a function to vary the data transfer speed depending on whether power feed of the first power by the power supply terminal is received or the second power by the power supply unit is received.

The embodiments of the present invention provide an advantage that power supply and data transmission and reception can be accordingly selected and handled depending on the necessary transfer speed and the power consumption.

### BRIEF DESCRIPTION OF THE DRAWINGS

FIG. 1 is a diagram showing a configuration example of a card system employing a card peripheral device according to a first embodiment of the present invention;

FIG. 2 is a perspective view showing a first configuration example of a memory card according to the first embodiment;

FIG. 3 is a perspective view showing a second configuration example of the memory card according to the first embodiment;

FIG. 4 is a diagram for explaining the principle of non-contact power feed;

FIGS. 5A and 5B are flowcharts for explaining the processing of a first operating mode that is high-speed mode operation in contact power supply;

FIGS. 6A and 6B are flowcharts for explaining the processing of a second operating mode that is low-speed mode operation in contact power supply;

FIGS. 7A and 7B are flowcharts for explaining the processing of a third operating mode that is low-speed mode operation in non-contact power supply;

FIG. 8 is a diagram showing a configuration example of a card system employing a card peripheral device according to a second embodiment of the present invention;

FIGS. 9A and 9B are diagrams showing a first configuration example of a memory card having power supply terminals at its side parts according to a third embodiment of the present invention;

FIGS. 10A and 10B are diagrams showing a second configuration example of the memory card having power supply terminals at its side parts according to the third embodiment of the present invention;

FIG. 11 is a diagram showing one example of the contact state of a connector in power feed by a side-surface power supply terminal in the third embodiment;

FIG. 12 is a diagram showing a configuration example of a memory card having power supply terminals at its side parts according to a fourth embodiment of the present invention;

FIG. 13 is a diagram showing one example of the contact state of a connector in power feed by a side-surface power supply terminal in the fourth embodiment;

FIGS. 14A and 14B are diagrams showing a configuration example of a memory card having power supply terminals at its side parts according to a fifth embodiment of the present invention;

FIG. 15 is a diagram showing one example of the contact state of a connector in power feed by a side-surface power supply terminal in the fifth embodiment;

FIG. 16 is a diagram showing a first configuration example of a memory card formed as a wireless card through elimination of a power supply terminal and a signal terminal according to a sixth embodiment of the present invention;

FIGS. 17A and 17B are diagrams showing a second configuration example of the memory card formed as a wireless card through elimination of a power supply terminal and a signal terminal according to a seventh embodiment of the present invention; and

FIGS. 18A and 18B are diagrams showing a configuration example of a memory card having a power supply terminal and a ground terminal at its side parts according to an eighth embodiment of the present invention.

### DETAILED DESCRIPTION OF THE PREFERRED EMBODIMENTS

Embodiments of the present invention will be described below in association with the drawings.

The order of the description is as follows.

### 1. First Embodiment

### 2. Second Embodiment

### 3. Third Embodiment

### 4. Fourth Embodiment

### 5. Fifth Embodiment

### 6. Sixth Embodiment

### 7. Seventh Embodiment

### 8. Eighth Embodiment

### 1. First Embodiment

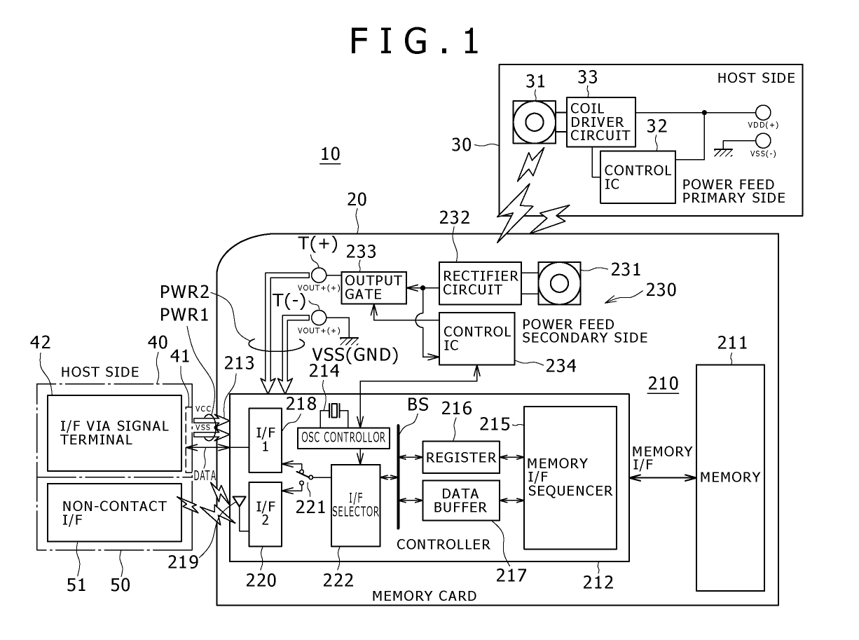

FIG. 1 is a diagram showing a configuration example of a card system employing a card peripheral device according to a first embodiment of the present invention.

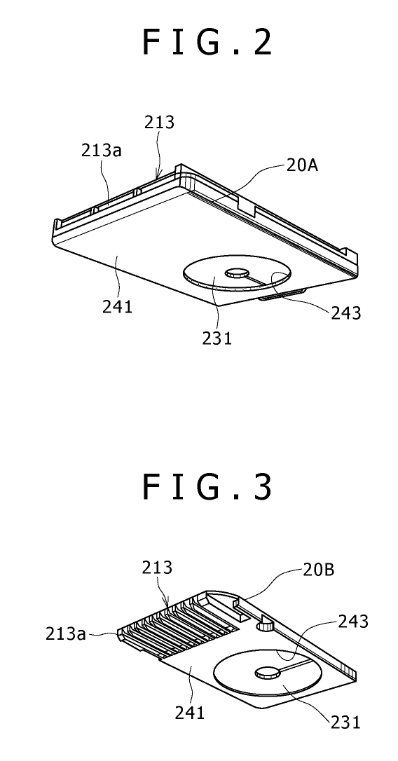

FIG. 2 is a perspective view showing a first configuration example of a memory card according to the present embodiment.

FIG. 3 is a perspective view showing a second configuration example of the memory card according to the present embodiment.

This card system 10 includes a memory card 20 as a card peripheral device, a host-side (primary-side) power supply device 30, a first host device 40, and a second host device 50.

The first host device 40 and the second host device 50 may be integrally disposed as electronic apparatus such as one camcorder or personal computer (PC), or may be configured as different pieces of apparatus.

The host-side power supply device 30 may be disposed integrally with the second host device 50, or may be configured as different apparatus.

The memory card 20 has an electronic part unit 210 that operates by first power PWR1 or second power PWR2. The first power PWR1 is directly supplied from the first host device 40 via a power supply terminal in the contact state. The second power PWR2 originates from reception of non-contact power supply by the power supply device 30.

The memory card 20 has a secondary-side power supply unit 230 that generates the second power, which originates from reception of non-contact power supply by the power supply device 30.

As the power supply terminal for receiving the first power PWR1 in the contact state, e.g. a power supply terminal arranged in parallel to a signal terminal can be employed.

Furthermore, as the power supply terminal for receiving the first power PWR1 in the contact state, an external power supply terminal (side surface electrode) formed on e.g. the side surface part of the memory card 20 can be employed as described in detail later.

In this case, a connector contact maker or the like is provided that is capable of contacting with the power supply terminal on the side surface of the memory card 20 and feeding power in the state in which the memory card 20 is connected to the first host device 40 via a connector part.

As shown in FIG. 1, the electronic part unit 210 of the memory card 20 according to the present embodiment includes, in its inside, a non-volatile memory 211 as a flash memory, a controller 212, and a connector part 213 for connection to a connector part 41 of the first host device 40.

The controller 212 has a crystal oscillator 214, a memory interface sequencer 215, a register 216, a data buffer 217, and a first interface (I/F1) 218 on the side of the connector part 213.

The controller 212 includes a communication antenna 219, a second interface (I/F2) 220 that executes wireless communication processing with the second host device 50, a changeover switch 221, an interface selector 222, and a bus BS.

The connector part 213 has a terminal part including a signal terminal and a power supply terminal that are arranged in one row and are for performing recording and reading through access from the first host device 40 outside the memory card to the non-volatile memory 211 via the controller 212.

This terminal part 213a enables the memory card 20 to receive supply of the first power PWR1 and exchange (transmit and receive) data via a contact pin of a connector existing in host apparatus (not shown).

Furthermore, the memory card 20 can transmit and receive data to and from the second host device 50 via the communication antenna 219 by a near-field wireless system.

Also in this case, it is also possible to receive the first power via the terminal part of the connector part 213, and it is also possible to receive the second power PWR2 from the secondary-side power supply unit 230.

Whether the memory card 20 transmits and receives data via the connector part 213 and the first interface 218 or transmits and receives data via the communication antenna 219 and the second interface is accordingly selected by the interface selector 222.

The interface selector 222 accordingly selects the changeover of the changeover switch 221 depending on the data transfer mode for example.

For example in the case of a high-speed transfer mode or in the case of transferring data by the signal terminal in a low-speed transfer mode, the interface selector 222 switches the changeover switch 221 so that the data may be transmitted and received via the connector part 213 and the first interface 218.

In the case of carrying out wireless communication in the low-speed transfer mode of data, the interface selector 222 switches the changeover switch 221 so that the data may be transmitted and received via the communication antenna 219 and the second interface 220.

The present embodiment has, as the operating mode, a high-speed mode (first operating mode) in which the power consumption is higher than that in a low-speed mode for example in contact power supply via the connector part 213, and the low-speed mode (second operating mode) in contact power supply.

Furthermore, the present embodiment has, as the operating mode, a low-speed mode (third operating mode) in non-contact power supply by use of the primary-side power supply device 30.

In this card system 10, the control corresponding to these operating modes is carried out in the memory card 20 and the host devices 40 and 50.

The first power PWR1 by the contact power supply includes a voltage VCC and a reference voltage VSS.

Control of them will be described in further detail later.

In other words, in the present embodiment, for example in the high-speed transfer mode, in which the power consumption is higher than that in the low-speed transfer mode, the control is so carried out that supply of the first power is received and data is exchanged (transmitted and received) by the terminal part via the contact pin of the connector existing in host apparatus (not shown).

In the low-speed transfer mode, whether to receive the second power PWR2 from the secondary-side power supply unit 230 or receive supply of the first power PWR1 is accordingly selected.

As shown in FIG. 2 and FIG. 3, memory cards 20A and 20B are formed into a parallelepiped shape, and the electronic part unit 210 and the secondary-side power supply unit 230 are mainly housed between a first surface 241 of a case body 240 and a second surface 242 (not shown) as the surface opposed to the first surface 241.

One or plural terminal parts 213a of the connector part 213 are formed at one end part of the longitudinal direction of the memory cards 20A and 20B.

Furthermore, in the memory cards 20A and 20B of the present embodiment, a coil housing part 243 in which a secondary-side coil 231 of the secondary-side power supply unit 230 is housed is formed at substantially the center part of the first surface 241 for example.

The secondary-side power supply unit 230 has the secondary-side coil 231, a rectifier circuit 232, an output gate 233, a control IC (Integrated Circuit) (controller) 234, and power supply terminals T(+) and T(−).

The secondary-side power supply unit 230 rectifies, by the rectifier circuit 232, the current generated in the secondary-side coil 231 due to electromagnetic induction by the primary-side power supply device 30, and supplies a DC voltage to the flash memory 211, the controller 212, and the control IC 234 in the memory card 20.

The secondary-side power supply unit 230 supplies a DC voltage VOUT(+) output from the output gate 233 via the power supply terminal T(+), and the power supply terminal T(−) is connected to the reference potential VSS (ground potential GND).

The secondary-side power supply unit 230 controls output and non-output of the DC voltage rectified by the control IC 234.

The control IC 234 can be so configured as to control the output gate 233 in such a way that the output of the DC voltage is set to non-output in the data high-speed transfer mode and the DC voltage is output in the low-speed transfer mode for example.

This configuration is one example, and it is also possible to employ a configuration in which the DC voltage is supplied from the output gate 233 if the control IC 234 receives the DC voltage from the rectifier circuit 232.

The primary-side power supply device 30 has a primary-side coil 31, a control IC 32, and a coil driver circuit 33 as components on the power feeding side.

The control IC 32 and the coil driver circuit 33 operate through reception of a supply voltage VDD and the reference potential VSS.

The primary-side power supply device 30 transmits power to the secondary-side power supply unit 230 of the memory card 20, which is on the power receiving side, in a non-contact (wireless) manner.

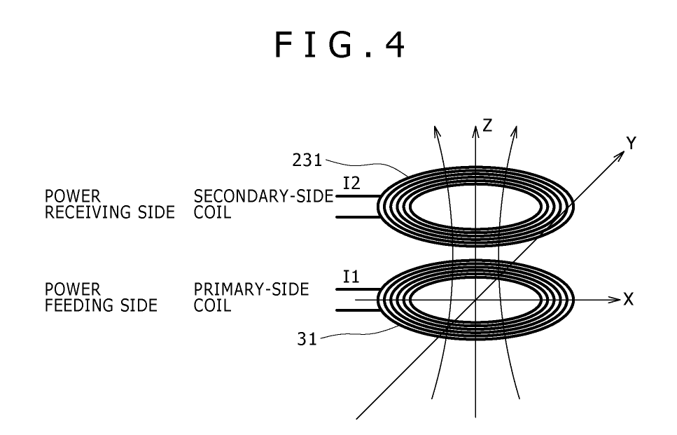

FIG. 4 is a diagram for explaining the principle of the non-contact power feed.

As shown in FIG. 4, under the control by the control IC 32, the coil driver circuit 33 of the power supply device 30 makes a current I1 flow through the primary-side coil 31 on the power feeding side, to generate a current I2 in the secondary-side coil 231 on the power receiving side in the memory card 20 by electromagnetic induction.

In the secondary-side power supply unit 230 of the memory card 20, the induced current I2 is rectified, so that the DC voltage dependent on the current is supplied to the flash memory 211 and the controller 212.

The first host device 40 is configured by apparatus such as a personal computer (PC), a digital still camera, a digital camcorder, or an audio recorder.

The first host device 40 has a CPU as a control system, a memory, a display, and an input/output processor (I/O), which are not shown in the diagram, and has the connector part 41 for connection to the memory card 20 and a memory interface (I/F) 42.

The connector part 213 of the memory card 20 is connected to the connector part 41, and thereby plural signal terminals and power supply terminals are brought into contact with and connected to the first host device 40.

The first host device 40 has a function to detect whether the memory card is in the connected state or the non-connected state, and has a function to carry out authentication and data transmission and reception with the memory card 20 in the connected state via the signal terminal.

The first host device 40 has a function to transmit and supply the first power PWR1 to the memory card 20 in the connected state via the power supply terminal.

The first host device 40 has a function to issue e.g. a speed transition command when carrying out the high-speed mode operation in contact power supply, which is the first operating mode, with the memory card 20 in the connected state for example.

The second host device 50 is configured by apparatus such as a personal computer (PC), a digital still camera, a digital camcorder, or an audio recorder.

The second host device 50 has a non-contact communication interface (I/F) 51 capable of near-field wireless communication with the memory card 20.

The non-contact communication interface 51 includes an inductor coil for communication and a transmitting/receiving circuit (modulating/demodulating circuit).

The second host device 50 has a function to determine whether non-contact (wireless) communication is in the established state or the non-established state via the communication antenna 219 and the second interface 220 in the memory card 20 brought close to the second host device 50.

The second host device 50 has a function to carry out wireless data transmission and reception appropriate for the so-called low-speed mode if the non-contact communication is in the established state.

As described above, in the card system 10 of the present embodiment, the memory card 20 has, in its inside, the flash memory 211 and the controller 212 to control it.

The memory card 20 has the connector part 213 in which plural signal terminals and power supply terminals are arranged in parallel for data recording and reading from the external of the card.

If this contact-type data recording-and-reading function is defined as a first recording-and-reading communication function, the memory card 20 includes a non-contact near-field wireless communication function as a second recording-and-reading communication function, and uses it exclusively from the first recording-and-reading communication function.

For example, if supply of the first power PWR1 is received from the power supply terminals of the connector part 213, data recording and reading are performed by using the signal terminals disposed in parallel. This function is equivalent to that in the use mode of a normal memory card.

The memory card 20 has a function to supply power to the electronic part unit 210 by the secondary-side power supply unit 230, which is a non-contact power transmitting function for power feeding in wireless communication.

In the present embodiment, an electromagnetic induction system like that shown in FIG. 4 is employed as the principle of power supply. However, the system is not limited to the electromagnetic induction system.

As described above, the current I1 is made to flow through the primary-side coil 31 on the power feeding side in FIG. 4, and the current I2 generated in the secondary-side coil 231 on the power receiving side due to electromagnetic induction is rectified to be supplied to the controller 212 and the flash memory 211 in the memory card 20.

However, in such power supply based on electromagnetic induction, presently it is difficult that the transmission efficiency surpasses 70 to 80% even under the best condition.

This condition depends mainly on the positions of the planar shapes of the power feeding side coil 31 and the power receiving side coil 231 and the distance therebetween, and so forth.

For the wireless data transfer, millimeter waves or the like can be utilized. However, generally the transfer speed and the power necessary for achieving the transfer speed are in a proportional relationship.

Therefore, it is easily inferred that, in the wireless data transfer, generally power higher than that in the contact state by connectors is required to achieve the maximum speed that can be realized in the contact state.

The memory card 20 of the present embodiment has two kinds of power feed functions, i.e. the power feed function for the non-contact state and that for the contact state, and has a function to vary the data transfer speed depending on the method of the power feed (the amount of supplied power).

For example, when wireless data transfer is carried out but the necessary power surpasses the power that can be supplied by non-contact power feed, the card cannot transfer data at the maximum speed in wireless communication and wireless (non-contact) power feed.

If power feed by the connector part 213 is possible in a situation in which high-speed transfer is necessary, the memory card 20 carries out data transfer operation of the card by contact power feed from the power supply terminal. If non-contact power feed operation is carried out, the memory card 20 is switched to the low-speed mode, in which the memory card 20 operates by low power.

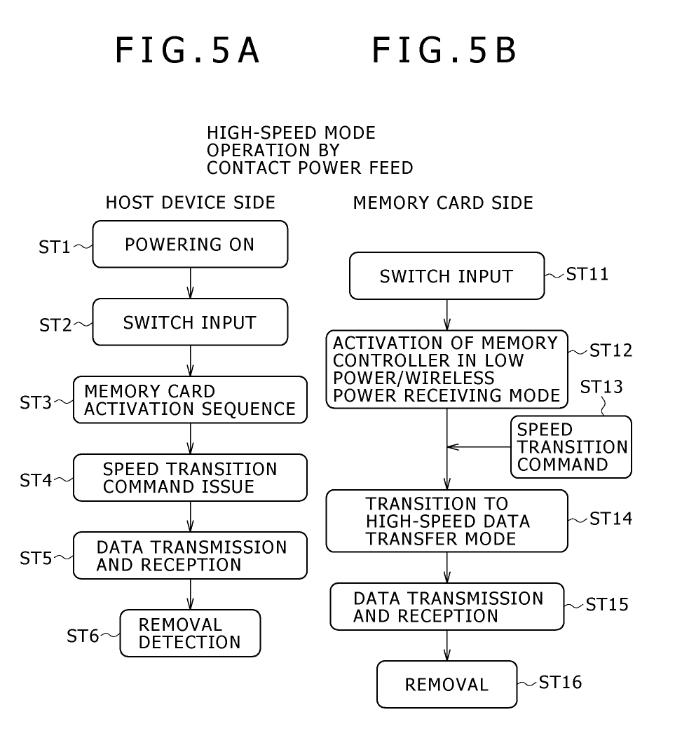

Descriptions will be made below in association with FIGS. 5 to 7 about the processing of the first operating mode, which is the high-speed mode operation in contact power supply, the second operating mode, which is the low-speed mode operation in contact power supply, and the third operating mode, which is the low-speed mode operation in non-contact power supply.

First, the processing of the first operating mode, which is the high-speed mode operation in contact power supply, will be described in association with FIGS. 5A and 5B.

FIGS. 5A and 5B are flowcharts for explaining the processing of the first operating mode, which is the high-speed mode operation in contact power supply. FIG. 5A shows the processing of the host device side, and FIG. 5B shows the processing of the memory card side.

In the first operating mode, the first host device 40 and the memory card 20 are in the connected state by the connector part 41 and the connector part 213. Power is supplied from the first host device 40 to the memory card 20 in the contact state.

In the first host device 40, after powering on (ST1), upon switch input (ST2), a memory card activation sequence starts (ST3).

Next, in the first host device 40, a speed transition command for transition of the speed from low-speed transfer to high-speed transfer is issued and transferred to the memory card 20 (ST4).

After the transition of the memory card 20 to the first operating mode, which is the high-speed data transfer mode, the first host device 40 carries out data transmission and reception with the memory card 20 (ST5).

Subsequently, for example when the data transmission and reception are ended and the connector part 213 of the memory card 20 is removed from the connector part 41 of the first host device 40, the removal of the memory card 20 is detected (ST6).

In the memory card 20, upon switch input (ST11), the memory controller 212 is activated in the low-power, non-contact (wireless) power receiving mode (ST12).

After the activation, the memory controller 212 receives the speed transition command from the first host device 40 (ST13).

This makes the transition of the memory card 20 to the first operating mode, which is the high-speed data transfer mode (ST14).

Under the control by the memory controller 212, data transmission and reception in the first operating mode, which is the high-speed data transfer mode, are carried out (ST15).

Subsequently, for example the data transmission and reception are ended and the connector part 213 of the memory card 20 is removed from the connector part 41 of the first host device 40 (ST16).

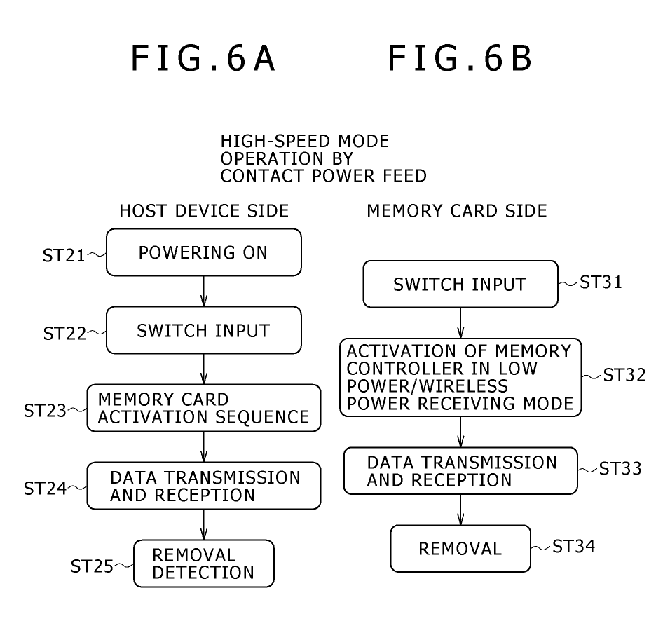

Next, the processing of the second operating mode, which is the low-speed mode operation in contact power supply, will be described in association with FIGS. 6A and 6B.

FIGS. 6A and 6B are flowcharts for explaining the processing of the second operating mode, which is the low-speed mode operation in contact power supply. FIG. 6A shows the processing of the host device side, and FIG. 6B shows the processing of the memory card side.

Also in the second operating mode, the first host device 40 and the memory card 20 are in the connected state by the connector part 41 and the connector part 213. Power is supplied from the first host device 40 to the memory card 20 in the contact state.

In the first host device 40, after powering on (ST21), upon switch input (ST22), a memory card activation sequence starts (ST23).

When the memory card 20 has become capable of data transfer, the first host device 40 carries out data transmission and reception with the memory card 20 (ST24).

Subsequently, for example when the data transmission and reception are ended and the connector part 213 of the memory card 20 is removed from the connector part 41 of the first host device 40, the removal of the memory card 20 is detected (ST25).

In the memory card 20, upon switch input (ST31), the memory controller 212 is activated in the low-power, non-contact (wireless) power receiving mode (ST32).

Under the control by the memory controller 212, data transmission and reception in the second operating mode, which is the low-speed data transfer mode, are carried out (ST33).

Subsequently, for example the data transmission and reception are ended and the connector part 213 of the memory card 20 is removed from the connector part 41 of the first host device 40 (ST34).

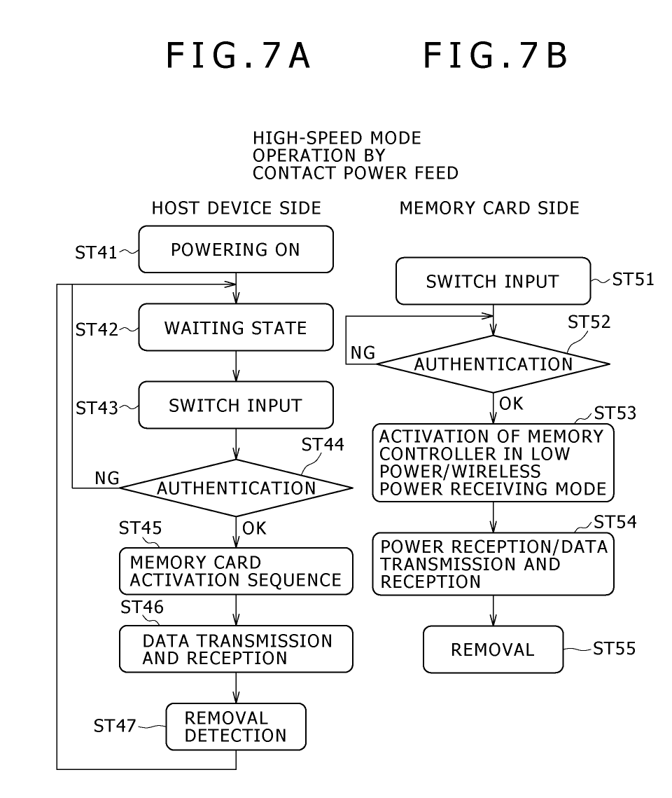

Next, the processing of the third operating mode, which is the low-speed mode operation in non-contact power supply, will be described in association with FIGS. 7A and 7B.

FIGS. 7A and 7B are flowcharts for explaining the processing of the third operating mode, which is the low-speed mode operation in non-contact power supply. FIG. 7A shows the processing of the host device side, and FIG. 7B shows the processing of the memory card side.

In the third operating mode, the second host device 50 and the memory card 20 are in such a separated state as to be capable of wireless communication. The memory card 20 is disposed close to the host-side power supply device 30 and supplied with power from the host-side power supply device 30 in the non-contact state.

In the second host device 50, after powering on (ST41), the waiting state starts (ST42). Upon switch input (ST43), authentication with the memory card 20 is wirelessly carries out (ST44).

In the second host device 50, if authentication is successful in the step ST44, a memory card activation sequence starts (ST45).

When the memory card 20 has become capable of data transfer, the second host device 50 carries out data transmission and reception with the memory card 20 (ST46).

Subsequently, for example when the data transmission and reception are ended and the connector part 213 of the memory card 20 is separated (removed) from the second host device 50 by a distance across which wireless communication is difficult, the separation is detected as the removal of the memory card 20 (ST47).

In the memory card 20, upon switch input (ST51), authentication with the second host device 50 is wirelessly carried out (ST52).

In the memory card 20, if authentication is successful in the step ST52, the memory controller 212 is activated in the low-power, non-contact (wireless) power receiving mode (ST53).

Under the control by the memory controller 212, data transmission and reception in the third operating mode, which is the low-speed data transfer mode, are carried out in the power receiving state (ST54).

Subsequently, for example the data transmission and reception are ended and the memory card 20 is separated (removed) from the second host device 50 by a distance across which wireless communication is difficult (ST55).

In the above description, in the second operating mode, the low-speed data transfer is carried out not wirelessly but with the first host device 40. However, it is also possible to employ a configuration in which contact power supply is received from the first host device 40 and wireless communication is carried out with the second host device 50.

As described above, by the card system of the first embodiment, power supply and data transmission and reception can be accordingly selected and handled depending on the necessary transfer speed and the power consumption.

### 2. Second Embodiment

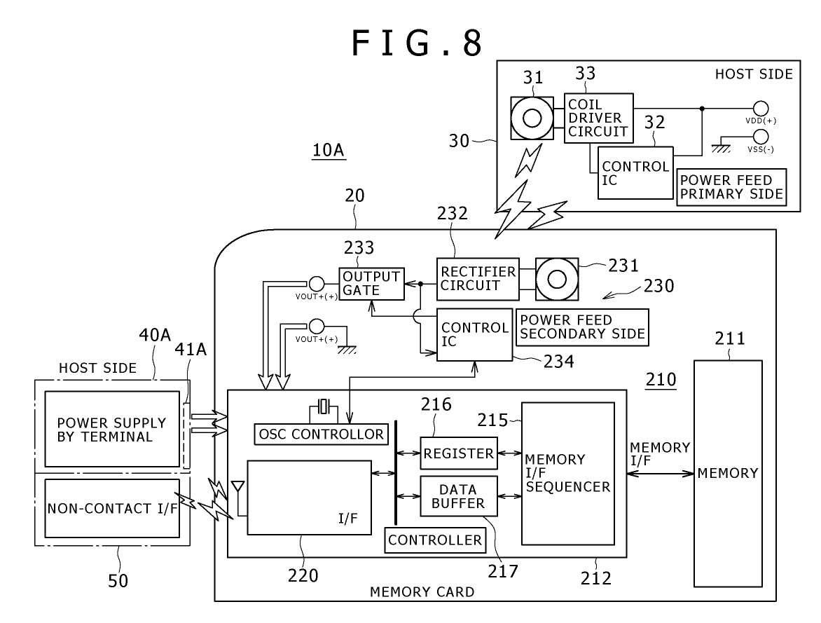

FIG. 8 is a diagram showing a configuration example of a card system employing a card peripheral device according to a second embodiment of the present invention.

A card system 10A according to the second embodiment is different from the card system 10 according to the first embodiment in that the signal terminal does not exist but only the power supply terminal exists as the connection terminal between a connector part 41A of a first host device 40A and the connector part 213 of the memory card 20.

In accordance with this, in the memory card 20, the first interface 218, the switch 221, and the interface selector 222 are unnecessary.

Except for that data transfer in the contact state is not carried out, this card system 10A is the same as the first embodiment.

The second embodiment can achieve the same advantageous effects as those by the first embodiment.

In the case of envisaging a situation in which wireless data transfer and contact power supply are carried out, it is unreasonable to insert a card into a slot having a connector for normal data communication for only power supply.

Furthermore, the non-contact power supply function leads to possession of a coil, a rectifier circuit, etc. in the card.

The possession of these components inside the card decreases the space for mounting the flash memory and possibly precludes a large increase in the recording capacity.

For these reasons, the combination of wireless data recording/reading and power supply by use of a contact terminal is practical for the memory card.

Descriptions will be made below about examples in which an external power supply terminal (side surface electrode) formed on e.g. the side surface part of the memory card 20 is employed as a power supply terminal for receiving power to the memory card 20 in the contact state.

### 3. Third Embodiment

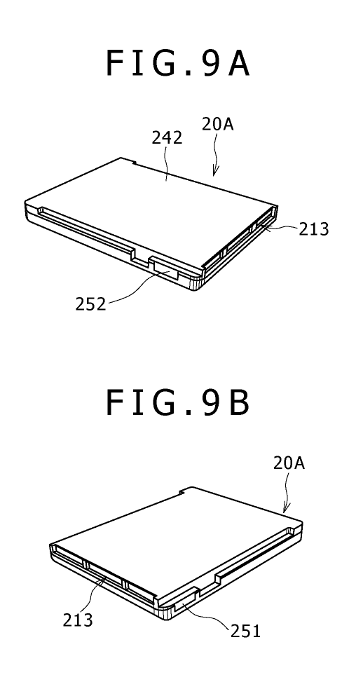

FIGS. 9A and 9B are diagrams showing a first configuration example of a memory card having power supply terminals at its side parts according to a third embodiment of the present invention.

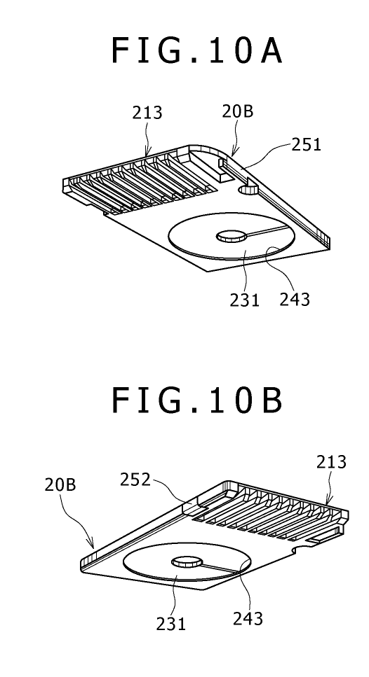

FIGS. 10A and 10B are diagrams showing a second configuration example of the memory card having power supply terminals at its side parts according to the third embodiment of the present invention.

A memory card 20A of FIGS. 9A and 9B is equivalent to the memory card of FIG. 2. However, FIGS. 9A and 9B are perspective views from the side of the second surface 242, and therefore the coil housing part is not shown in the drawings.

A memory card 20B of FIGS. 10A and 10B is equivalent to the memory card of FIG. 3.

As shown in the diagrams, in the memory cards 20A and 20B, side-surface power supply terminals 251 and 252 are disposed at both side parts of the longitudinal direction and near the connector part 213.

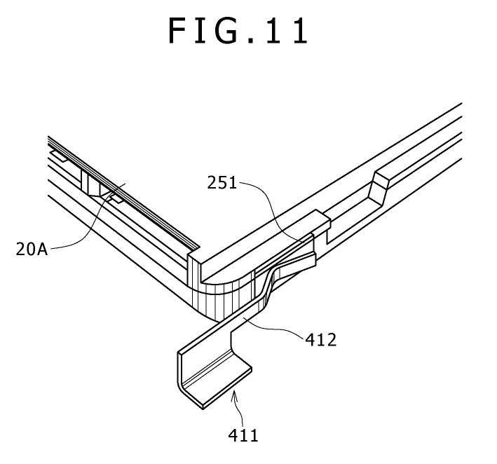

FIG. 11 is a diagram showing one example of the contact state of the connector in power feed by the side-surface power supply terminal in the third embodiment.

For example, in the connector part 41 or 41A of the first host device 40, a contact pin 412 or the like of a connector contact maker 411 is provided. The contact pin 412 can contact with the side-surface power supply terminal 251 (252) of the memory card 20A and feed power in the state in which the memory card 20A is connected to the first host device 40 via the connector part 213.

The contact pin 412 formed on the tip side of the contact maker 411 is endowed with elastic force for pressing against the inside of the memory card 20A, and applies pressing force to the side-surface power supply terminal 251 or 252 by the elastic force to thereby keep a favorable contact state.

Specifically, at least one of the contact pins 412 of the connector part serves also as a lock spring to hold the card in the connector.

### 4. Fourth Embodiment

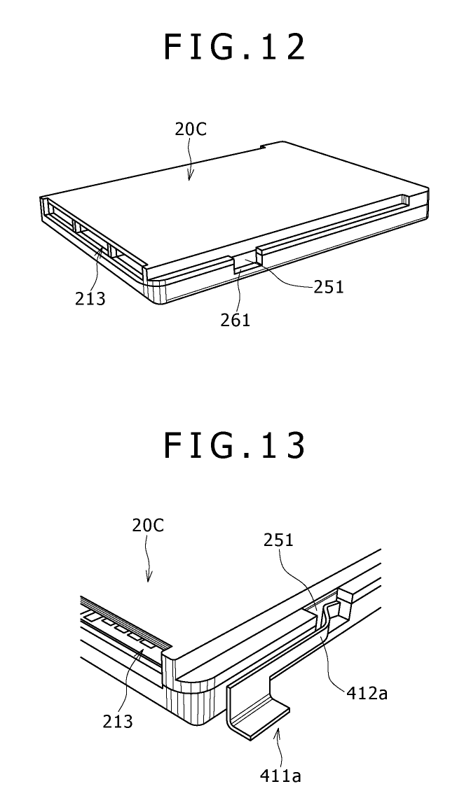

FIG. 12 is a diagram showing a configuration example of a memory card having power supply terminals at its side parts according to a fourth embodiment of the present invention.

A memory card 20C according to the fourth embodiment is different from the 20A according to the third embodiment in that the side-surface power supply terminal 251 is formed not near the connector part 213 but on the side surface in a notch 261 that is so formed on the card side surface as to hollow toward the inside.

FIG. 13 is a diagram showing one example of the contact state of the connector in power feed by the side-surface power supply terminal in the fourth embodiment.

Also in this case, in the connector part 41 or 41A of the first host device 40, a contact pin 412a or the like of a connector contact maker 411a is provided. The contact pin 412a can contact with the side-surface power supply terminal 251 of the memory card 20C and feed power in the state in which the memory card 20C is connected to the first host device 40 via the connector part 213.

The contact pin 412a formed on the tip side of the contact maker 411a is endowed with elastic force for pressing against the inside of the memory card 20C, and applies pressing force to the side-surface power supply terminal 251 or 252 by the elastic force to thereby keep a favorable contact state.

Specifically, at least one of the contact pins 412a of the connector part serves also as a lock spring to hold the card in the connector.

This configuration provides countermeasures against static electricity and protects the contact terminal from dirt attributed to a fingerprint or the like.

### 5. Fifth Embodiment

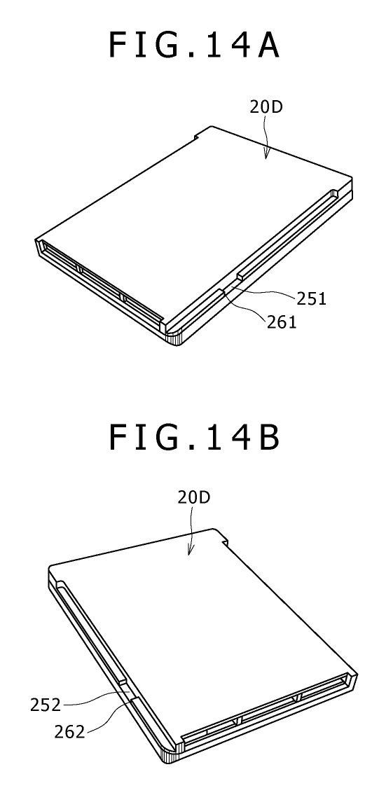

FIGS. 14A and 14B are diagrams showing a configuration example of a memory card having power supply terminals at its side parts according to a fifth embodiment of the present invention.

A memory card 20D according to the fifth embodiment is different from the memory card 20C according to the fourth embodiment in that the side-surface power supply terminals 251 and 252 are formed on not the side surfaces but the bottom surfaces in the notches 261 and 262 that are so formed on the card side surface as to hollow toward the inside.

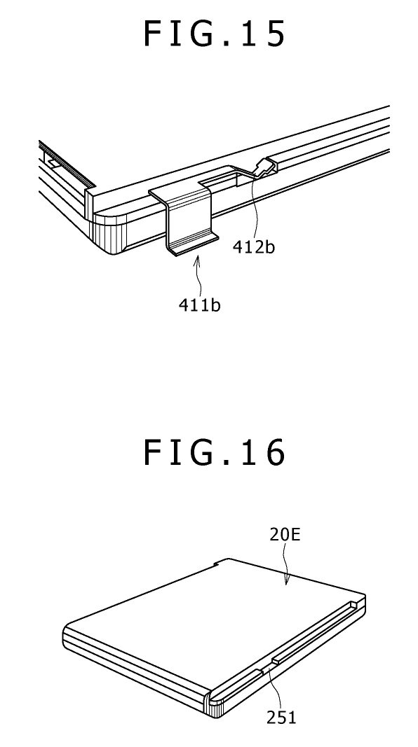

FIG. 15 is a diagram showing one example of the contact state of the connector in power feed by the side-surface power supply terminal in the fifth embodiment.

Also in this case, in the connector part 41 or 41A of the first host device 40, a contact pin 412b or the like of a connector contact maker 411b is provided. The contact pin 412b can contact with the side-surface power supply terminal 251 of the memory card 20D and feed power in the state in which the memory card 20D is connected to the first host device 40 via the connector part 213.

The contact pin 412b formed on the tip side of the contact maker 411b is endowed with elastic force for pressing against the surface 241 of the memory card 20D, and applies pressing force to the side-surface power supply terminal 251 or 252 by the elastic force to thereby keep a favorable contact state.

Specifically, at least one of the contact pins 412b of the connector part serves also as a lock spring to hold the card in the connector.

This configuration provides countermeasures against static electricity and protects the contact terminal from dirt attributed to a fingerprint or the like.

### 6. Sixth Embodiment

FIG. 16 is a diagram showing a first configuration example of a memory card formed as a wireless card through elimination of the power supply terminal and the signal terminal therefrom according to a sixth embodiment of the present invention.

A memory card 20E according to the sixth embodiment is shown as an example that functions as a card for only wireless signal communication and has only an external power supply terminal.

In this case, the card does not have the power feed function by a non-contact coil.

### 7. Seventh Embodiment

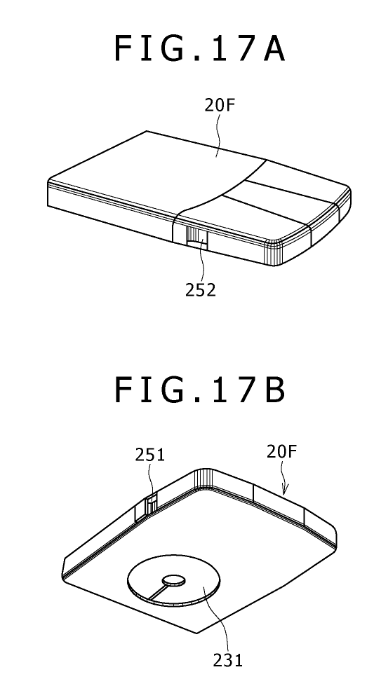

FIGS. 17A and 17B are diagrams showing a second configuration example of the memory card formed as a wireless card through elimination of the power supply terminal and the signal terminal therefrom according to a seventh embodiment of the present invention.

A memory card 20F according to the seventh embodiment functions as a card for only wireless signal communication and has the power feed function by the non-contact coil 231.

Furthermore, the memory card 20F has also the external power supply terminal 251 and has the same functions as those of the memory card according to the second embodiment.

### 8. Eighth Embodiment

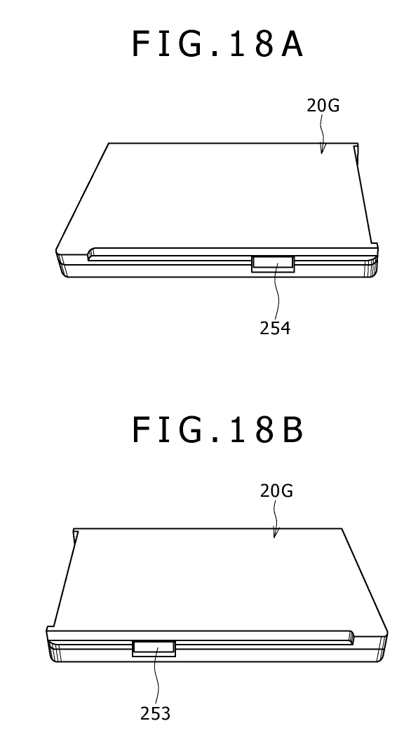

FIGS. 18A and 18B are diagrams showing a configuration example of a memory card having a power supply terminal and a ground terminal at its side parts according to an eighth embodiment of the present invention.

In a memory card 20G according to the eighth embodiment, either a power supply terminal 253 or a ground terminal 254 is disposed on each side surface, and the length of the ground terminal 254 is set larger than that of the power supply terminal 253.

Due to this configuration, the ground terminal 254 contacts with the connector earlier than the power supply terminal 253, which can reduce the risk of the breakdown of the card attributed to static electricity.

As described above, the embodiments of the present invention can achieve the following advantageous effects.

If both of wireless data transfer and non-contact power supply to a card are possible, the user can transfer data merely by placing the card in a usable area.

Furthermore, by supplying power by use of a power supply terminal or a power supply terminal provided independently of it depending on the case so that the speed of data transfer between a card and a host may be prevented from being lowered due to the limit to the amount of power supply in non-contact power supply, the data transfer can be carried out with the maximum ability (speed) originally possessed by the card and the host apparatus.

As the specifications of the card, a card having plural data terminals and power supply terminals, and in addition thereto a wireless communication function and a non-contact power supply function or an external power supply terminal are provided.

This makes it possible to keep compatibility in many pieces of apparatus and provide a use method appropriate for the condition.

The present application contains subject matter related to that disclosed in Japanese Priority Patent Application JP 2009-294082 filed in the Japan Patent Office on Dec. 25, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A card peripheral device comprising:
an electronic part unit configured to include a memory housed in a case body and receive first power or second power as operating power;
a connector part configured to include at least a power supply terminal for receiving the first power from connection-subject apparatus, out of the power supply terminal and a signal terminal, as a connection terminal connectable to the connection-subject apparatus; and
a power supply unit configured to receive power transmitted from an external in a non-contact manner to generate the second power and supply the second power to the electronic part unit, wherein
the electronic part unit includes
a controller, and
at least a second interface, out of a first interface capable of data transfer with the external via the signal terminal in accordance with control by the controller and the second interface capable of wireless data transfer with the external in accordance with control by the controller, and
the controller has a function to vary data transfer speed depending on whether power feed of the first power by the power supply terminal is received or the second power by the power supply unit is received.

2. The card peripheral device according to claim 1, wherein
the card peripheral device has a low-speed mode in which data is transferred at low speed and a high-speed mode in which data is transferred at high speed causing power consumption higher than power consumption in the low-speed mode, and
when operation in the high-speed mode is necessary, the controller carries out data transfer operation in the high-speed mode by the first power if power feed of the first power is possible.

3. The card peripheral device according to claim 2, wherein
the controller carries out data transfer operation in the low-speed mode by the second power if only power feed of the second power is possible.

4. The card peripheral device according to claim 1, wherein
the power supply terminal and the signal terminal are included in the connector part, and
the controller includes the first interface and the second interface, and carries out communication with the external by exclusively using the first interface and the second interface.

5. The card peripheral device according to claim 1, wherein
the card peripheral device has a low-speed mode in which data is transferred at low speed and a high-speed mode in which data is transferred at high speed causing power consumption higher than power consumption in the low-speed mode, and
the controller carries out data transfer via the first interface or the second interface if the controller operates in the low-speed mode, and
the controller carries out data transfer via the first interface if the controller operates in the high-speed mode.

6. The card peripheral device according to claim 1, wherein
the power supply terminal is formed at a side surface part of the memory card.

7. The card peripheral device according to claim 1, wherein
a power supply terminal and a ground terminal are provided at both side surface parts of the memory card, and
the power supply terminal and the ground terminal are so disposed that the ground terminal contacts with a contact maker of contact-subject apparatus earlier than the power supply terminal.

8. A card system comprising:
a card peripheral device configured to have a connector part;
a first host device configured to be connected to the card peripheral device via the connector part and be capable of supplying first power;
a second host device configured to be capable of wireless communication with the card peripheral device; and
a power supply device configured to be capable of transmitting power to the card peripheral device in a non-contact manner, wherein
the card peripheral device includes
an electronic part unit that includes a memory housed in a case body and receives the first power or second power as operating power,
the connector part that includes at least a power supply terminal for receiving the first power from the first host device, out of the power supply terminal and a signal terminal, as a connection terminal connectable to the first host device, and
a power supply unit that receives power transmitted from an external in a non-contact manner to generate the second power and supply the second power to the electronic part unit,
the electronic part unit includes
a controller, and
at least a second interface, out of a first interface capable of data transfer with the first host device via the signal terminal in accordance with control by the controller and the second interface capable of wireless data transfer with the second host device in accordance with control by the controller, and
the controller has a function to vary data transfer speed depending on whether power feed of the first power by the power supply terminal is received or the second power by the power supply unit is received.
